(19) United States
(12) Patent Application Publication
(10) Pub. No.: US 2013/0331746 A1
(43) Pub. Date: Dec. 12, 2013

(54) EXERCISE, FITNESS, AND RECUPERATIVE MEDICINE DEVICE WITH VIBRATIONAL CORE

(71) Applicant: TIMEFIGHTER FITNESS LLC, Westlake Village, CA (US)

(72) Inventor: Andrew Brown, Thousand Oaks, CA (US)

(73) Assignee: TIMEFIGHTER FITNESS LLC, Westlake Village, CA (US)

(21) Appl. No.: 13/722,621

(22) Filed: Dec. 20, 2012

Related U.S. Application Data
(60) Provisional application No. 61/658,719, filed on Jun. 12, 2012.

(51) Int. Cl. A61H 1/00

(52) U.S. Cl. CPC A61H 1/00
USPC 601/46

(57) ABSTRACT

An exercise, fitness, and recuperative medicine device. The device includes a frame portion with at least three pairs of handles disposed around the frame portion, which handles are accessible via openings in the frame portion. The handles are joined to each other by bridge connectors, and each handle in a pair of handles are disposed on opposite sides of the frame portion. A vibratory core is positioned in the interior of the frame portion and is connected with standoffs to the bridge connectors. A control panel to control operation of the vibratory core.

### CROSS-REFERENCE TO RELATED APPLICATIONS

This application claims priority from U.S. Provisional Patent Application No. 61/658,719, filed Jun. 12, 2012.

### BACKGROUND OF THE INVENTION

The present invention relates generally to exercise devices, and more particularly to an exercise, fitness, and recuperative medicine device with a vibrational core that when used provides a tuned vibration workout for the toning and conditioning of selected muscle groups, ligaments, tendons and joints, stimulating growth and healing without high risk/strain exercise. Low frequency vibration has well-known positive effects on the human body.

Many people do not have the time or knowledge necessary to perform exercises that benefit stabilizer muscles or multi-muscle movements without the risk of heavy weights or dangerous body positions or apparatus. The invention solves this problem by providing a vibration-based workout that targets specific muscle pairs and their surrounding support muscles without the risk of picking up and handling heavy weights, or working out in awkward positions or using risky equipment. The invention forces the body to try to cancel the vibration with the use of primary, secondary, and tertiary muscle groups all at the same time. This saves time and eliminates risks associated with use of more traditional means, including heavy dead weights.

There are several elements associated with good fitness. These elements include flexibility, balance, strength, explosive speed and strength, and endurance. Traditional strength training can be time consuming and unduly load the body with heavy static weights, which can increase the potential for injury. Cardio training tends to focus on toning and building endurance more than building muscle, and can have the deleterious aspect of overly impacting and stressing muscles, joints, tendons, and ligaments. Harmonic vibration delivered to the body can be useful in triggering rapid muscle responses and improves strength, power, flexibility, circulation, bone density, balance, weight loss, cellulite reduction, hormonal balance, and recovery. This can activate a much higher percentage of muscle fibers compared to standard exercise routines.

However, most products that deliver harmonic vibration to the body require that the use stand on a vibrating plate that delivers the vibratory forces up through the user's feet, and thus do not deliver localized vibratory forces, e.g., such as to the upper body, arms, etc. These devices tend to be expensive, large in size, and limited in terms of how users can engage with the device. There accordingly remains a need for a device for delivering harmonic vibrations to more localized area of the body and in a greater variety of ways.

### SUMMARY OF THE INVENTION

The invention is an exercise, fitness, and recuperative medicine device, comprising:

a frame portion with a plurality of handles disposed around the frame portion, which handles are accessible via openings in the frame portion;

a vibratory core positioned in the interior of the frame portion; and

a control panel to control operation of the vibratory core.

In another embodiment the invention provides an exercise, fitness, and recuperative medicine device, comprising:

a frame portion with at least three pairs of handles disposed around the frame portion, which handles are accessible via openings in the frame portion, wherein the handles are joined to each other by bridge connectors, and wherein each handle in a pair of handles are disposed on opposite sides of the frame portion;

a vibratory core positioned in the interior of the frame portion and connected with standoffs to the bridge connectors; and

a control panel to control operation of the vibratory core.

### BRIEF DESCRIPTION OF THE DRAWINGS

FIG. 1 is a first perspective view of an embodiment of the exercise, fitness, and recuperative medicine device of the invention placed on an optional charging stand.

FIG. 2 is front view of the exercise, fitness, and recuperative medicine device and optional charging stand of FIG. 1.

FIG. 3 is a cutaway view showing an interior of the vibratory core of the exercise, fitness, and recuperative medicine device and optional charging stand of FIG. 1.

FIG. 4 is a top front view showing a control panel on the vibratory core of the exercise, fitness, and recuperative medicine device of FIG. 1.

FIG. 5 is a perspective view of the exercise, fitness, and recuperative medicine device of FIG. 1, but with the vibratory core removed.

FIG. 6 is a view of the exercise, fitness, and recuperative medicine device of FIG. 2, but with the vibratory core removed.

FIG. 7 is a perspective view showing an exemplary embodiment of a vibratory core portion of the exercise, fitness, and recuperative medicine device of the invention, with a top cover of the shell thereof removed.

FIG. 8 is diagrammatic view showing the exercise, fitness, and recuperative medicine device of FIG. 1 grasped by a user's hands and held between the user's thighs.

FIG. 9 is another exemplary embodiment of an exercise, fitness, and recuperative medicine device of the invention.

FIG. 10 is a further exemplary embodiment of an exercise, fitness, and recuperative medicine device of the invention.

FIG. 11 is yet another exemplary embodiment of an exercise, fitness, and recuperative medicine device of the invention.

### DETAILED DESCRIPTION

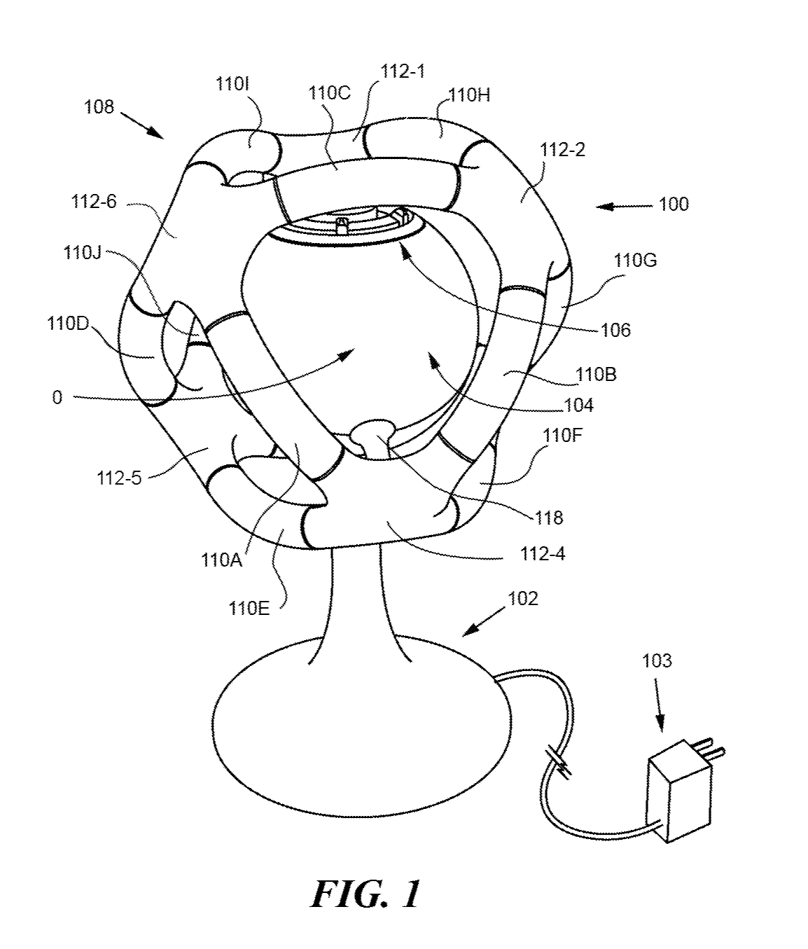

FIG. 1 is a first perspective view of an embodiment of the exercise, fitness, and recuperative medicine device of the invention placed on an optional charging stand.

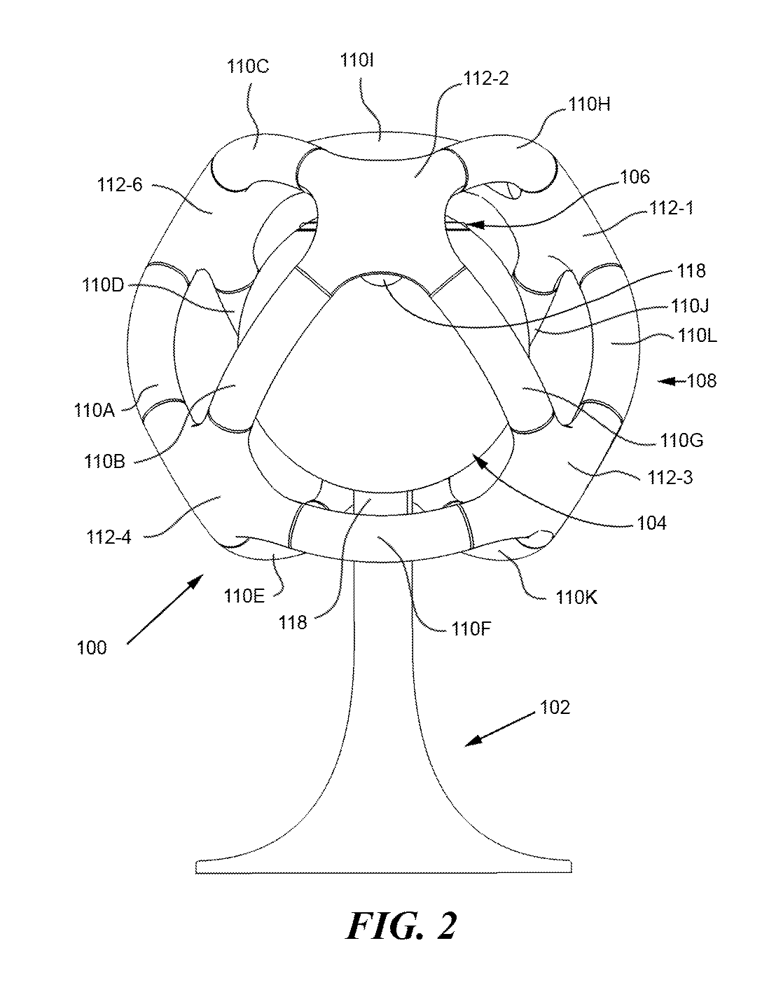

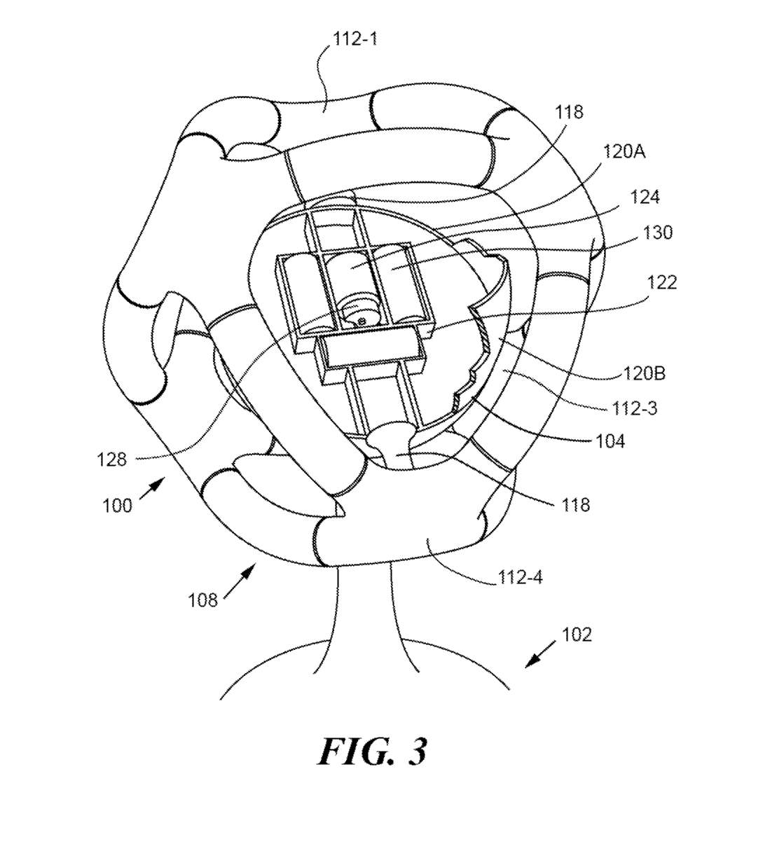

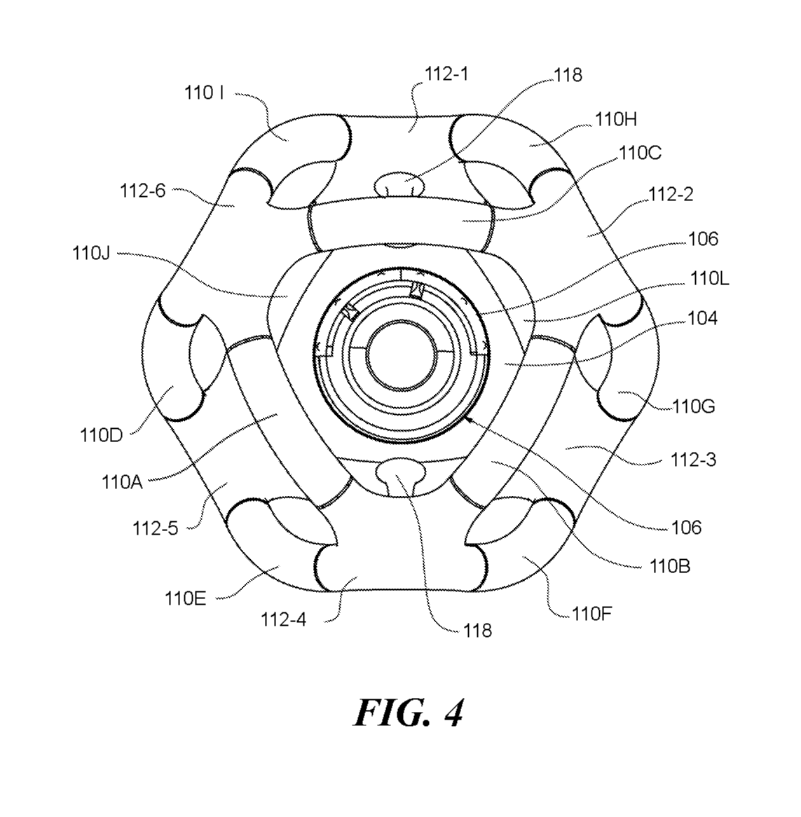

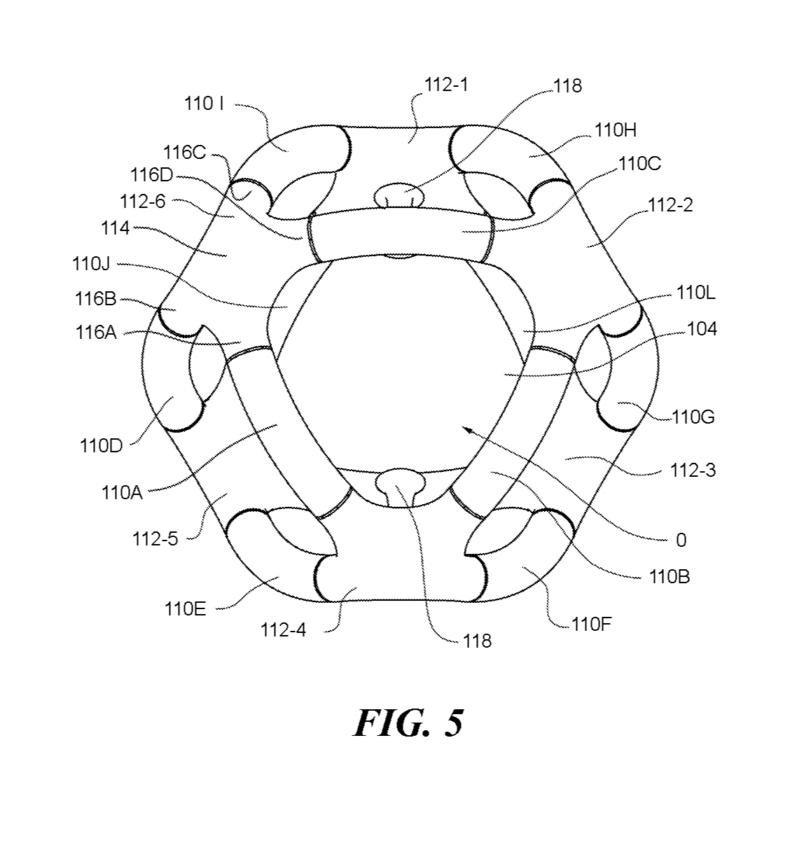

Turning first to FIGS. 1 to 4, these views show various views of an exemplary embodiment of an embodiment of the exercise, fitness, and recuperative medicine device 100 on an optional charging stand 102. FIG. 1 is a perspective view of the device 100 on the charging stand 102, FIG. 2 is front view of the device 100 and optional charging stand 102, FIG. 3 is a cutaway view showing an interior of the vibratory core 104, and FIG. 4 is a top front view showing a control panel 106 on the vibratory core 104 of the device. An exemplary external power supply 103 for the optional charging stand 102 is shown, but it could be integrated within the body of charging stand if desired. The exercise, fitness, and recuperative medicine device 100 has a frame portion 108 with a plurality of handle grips 110A-L with bridge connectors 112-1 to 112-6. The handle grips 110A-L sometime bear the reference number 110 and the bridge connectors 112 sometime bear the reference number 112. In this particularly embodiment, the frame portion 108 comprises twelve (12) handle grips 110 and six (6) bridge connectors 112, with each bridge connectors 112 connected to four (4) handle grips 110. The handle grips 110 can preferably be formed of, or covered with, pliable material for comfort. The handle grips 110 are preferably sized to be easily gripped by a wide range of users. The handle grips 110 and bridge connectors 112 can be adapted to snap together or be retained together in other known manners to form the frame portion 108. The handle grips 110 are shown as being slightly convexly curved and having a generally circular cross-section, but they can have other cross-sectional profiles, and can me straighter and flatter if desired. Referring to FIG. 5, the bridge connectors 112 can be flattened in their intermediate portion 114 and can have four arms 116A-D to which the handle grips 112 extend.

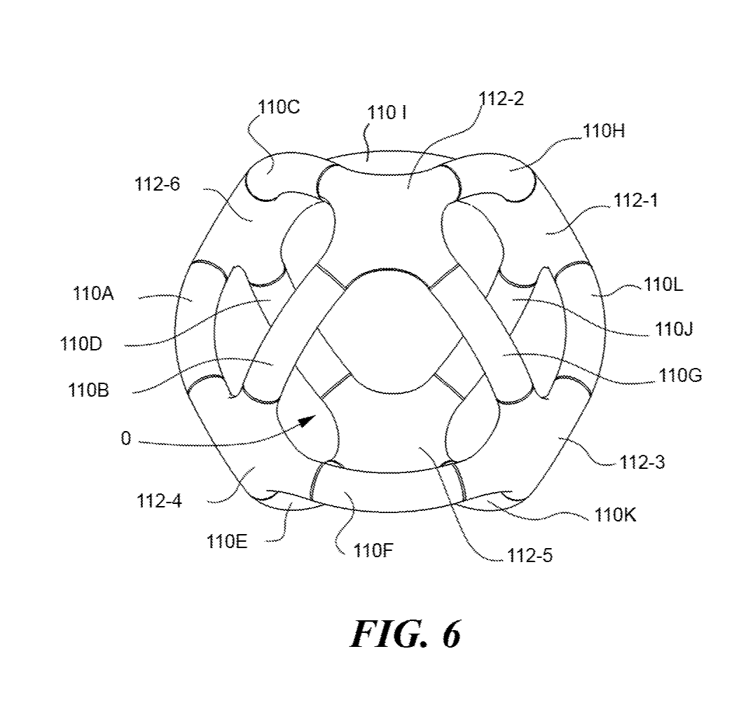

As best shown in FIGS. 5 and 6, sets of three handle grips 110, e.g., 110A, 110B, and 110C lie along a first general imaginary plane, and handle grips 110J, 110K, and 110L lie along a second general imaginary plane, which first and second general imaginary planes are an opposite sides of the frame portion 108. Between the three handles 110 in each plane, there are openings “O”, which openings O allow users to freely grasp the desired handles. A total of six such pairs of opposing general imaginary planes of three handles each exist, and allow a user to grip two symmetrically opposed handles, e.g., 110C and 110K, or 110H and 110E, or 110I and 110F, etc. Likewise, users can choose to grasp any arrangement of handle grips 110 and/or bridge connectors 112 desired.

Turning back to FIGS. 2 and 3, the vibratory core 104 is connected to the outer shell portion 108 via standoffs 118, which standoffs 118 extend between the vibratory core 104 and the outer shell portion 108. The standoffs 118 can comprise separate pieces, can be formed together with two of the bridge connectors 112, or can be formed together with the vibratory core 104.

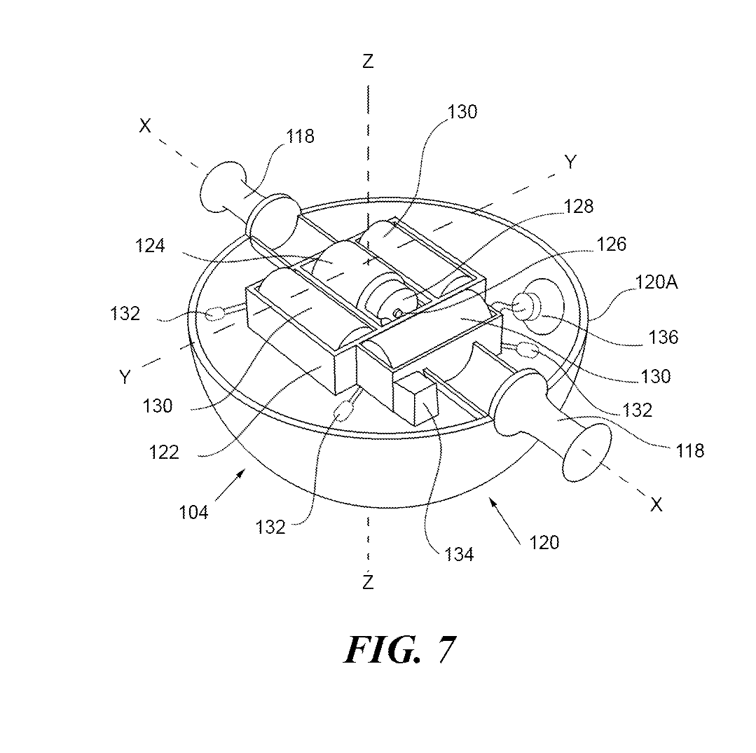

FIG. 3 is a cutaway view showing an interior of the vibratory core 104 of the exercise, fitness, and recuperative medicine device 100, and FIG. 7, is a perspective view of an exemplary embodiment of the vibratory core portion 104 with a top shell portion removed to reveal inner workings therein. The vibratory core 104 has an outer shell 120 with shell portions 120A and 120B. Contained in the outer shell 120 is a vibration carriage 122. In one embodiment an electric motor 124 with a shaft 126 and a cam weight 128 mounted on the shaft 126 is used to create the vibratory force by the rotating the cam weight, which is an off-center weight. The electric motor 124 is powered by batteries 130. The cam weight 128 is axially non-symmetrical so that when the electric motor 124 turns the cam weight 128, a vibration force will be generated.

As best shown in FIG. 7, which is a perspective view of the vibrational core portion 104 with the upper shell portion 120B removed, the standoffs 118 connect to the vibratory core 104 along an X-axis, which X-axis passes through the shaft 126 of the electric motor 124. When the cam weight 128 spins along the X-axis, it generates vibratory forces in the YZ plane. However, by arranging the orientation of the vibration carriage 122 differently, the vibrational forces can be generated in different planes. Other types of vibration inducing devices can be used, which may generate forces in other directions, e.g., along a single axis, along a single plane, or in three planes. The action of the electric motor 124 to drive the cam weight 128 will be controlled, such as on-off, interval of on-off, motor speed control (e.g., from very slow vibration or high speed vibration, and any combination or variations thereof). In addition, the mass of the cam weight 128 and the degree to which it is unsymmetrical influences the vibratory forces as well, and the mass and shape can be altered as desired. For visual appeal, the vibratory core 104 can have lights (e.g., LEDs) 132 located therein and the outer shell can be transparent or translucent so that light effects can be achieved. Likewise, the frame portion 108 can also be made to be partially or completely transparent or translucent so that light effects can be achieved. If desired, the exercise, fitness, and recuperative medicine device 100 can have sound processing circuitry 134 and a speaker 136 to provide sounds and/or voice prompts for users of the device, such as instructions for use, timing information, and the like.

Referring back to FIG. 4, it shows a control panel 106 on the vibratory core 104 of the device 100 that controls the electric motor 124. The control panel 106 preferably includes an on/off control, a speed control, timers, programmed routines, and controls for any optional lights and sounds and/or voice prompts.

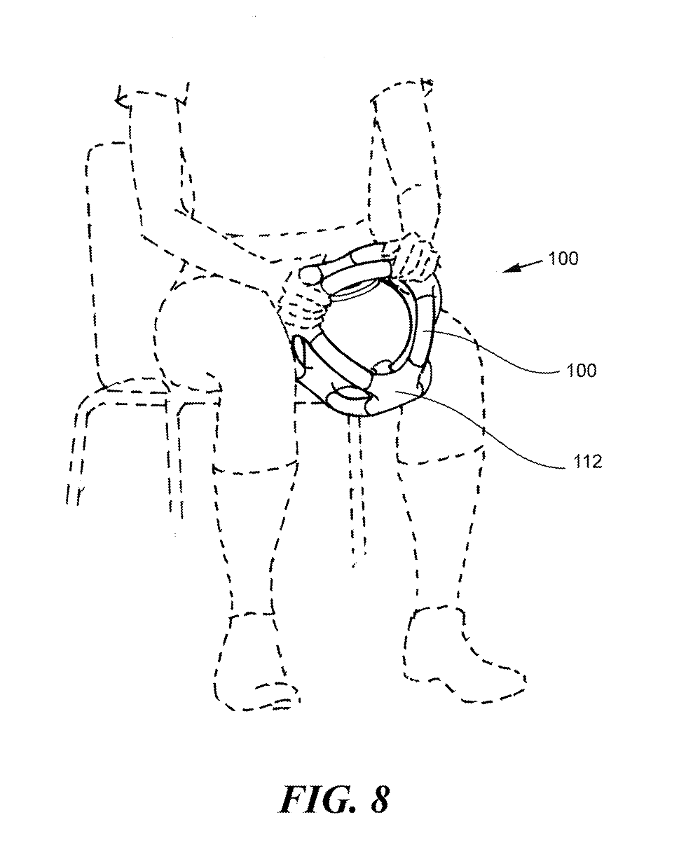

FIG. 8 is diagrammatic view showing the exercise, fitness, and recuperative medicine device 100 of FIG. 1 being grasped by a user's hands and held between the user's thighs. As can be seen the user can grip the frame portion 108 by placing his/her hands on the hand grips 110 and/or bridge connectors 112, and can rest other parts of the device between the knees and thighs. Particularly for invalids, or people who have difficulty or cannot walk, or those people who wish to stimulate the legs and lower body, this can be quite effective. Indeed, for those individuals who cannot or have difficulty exercising their legs, the exercise, fitness, and recuperative medicine device 100 allows the lower body to be exercised, without the user needing to stand up. As such, the device 100 is ideal for recuperative exercises.

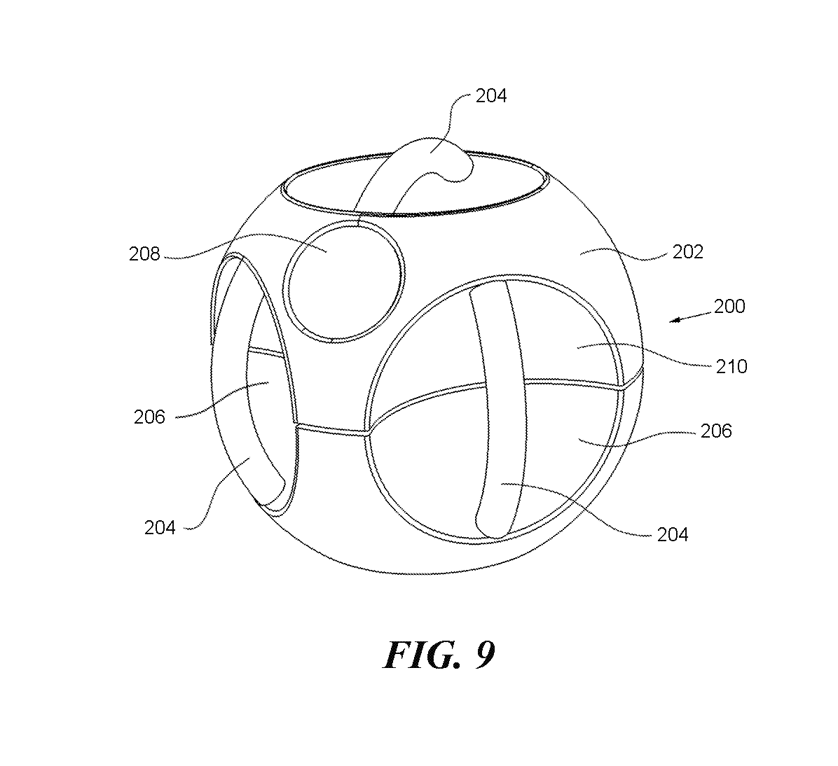

FIG. 9 is another exemplary embodiment of an exercise, fitness, and recuperative medicine device 200 of the invention. It includes a frame portion 202 with a series of handles 204. There are reliefs 206 that extend into the body of frame portion 202. A control panel 208 is accessible from the frame portion 202, which control panel 208 is for use in controlling the functions of the device 200. An internal vibratory core (not shown) contains the vibratory elements that produce the controlled vibrations. In this embodiment, there are six handles, with one handle at the top and bottom each and four on sides of the frame portion 202.

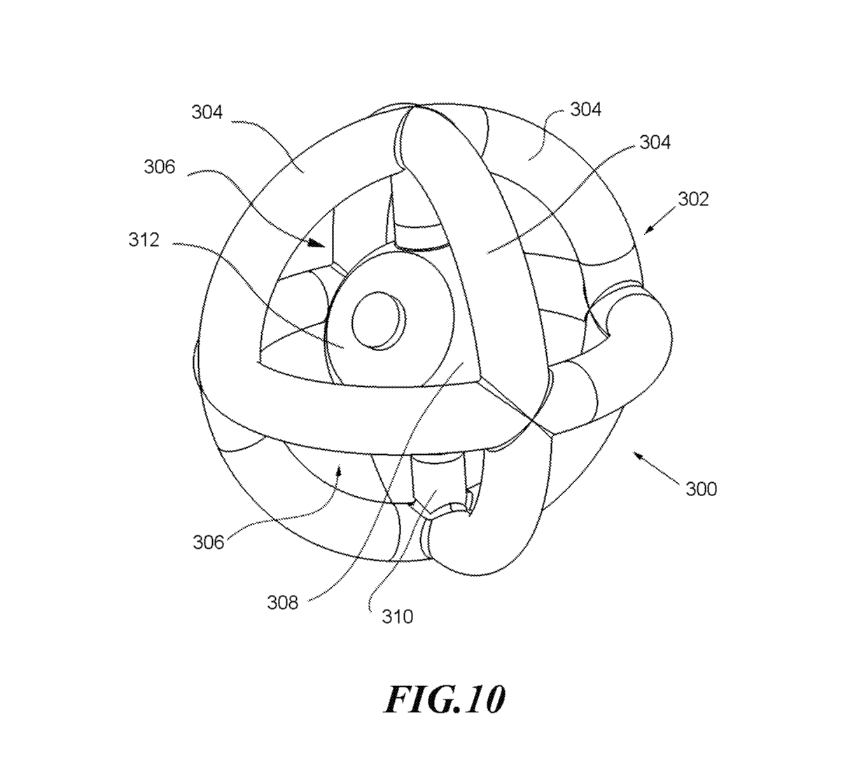

FIG. 10 is a further exemplary embodiment of an exercise, fitness, and recuperative medicine device 300 of the invention. It includes a frame portion 302 with a series of handles 304. In this embodiment, there are eight handles 304, with four handles 304 being located in an upper half of the device and four handles 304 being in the lower half of the device. Openings 306 are provided between the handles 304, and the vibratory core 308 is positioned in the center of the frame portion 302 and is connected thereto by standoffs 310. A control panel 312 is present on the vibratory core 308 and is accessible via the openings 306. This particular embodiment of the exercise, fitness, and recuperative medicine device 300 has eight handles 304, which are arced, giving the device 300 a generally cylindrical outer profile.

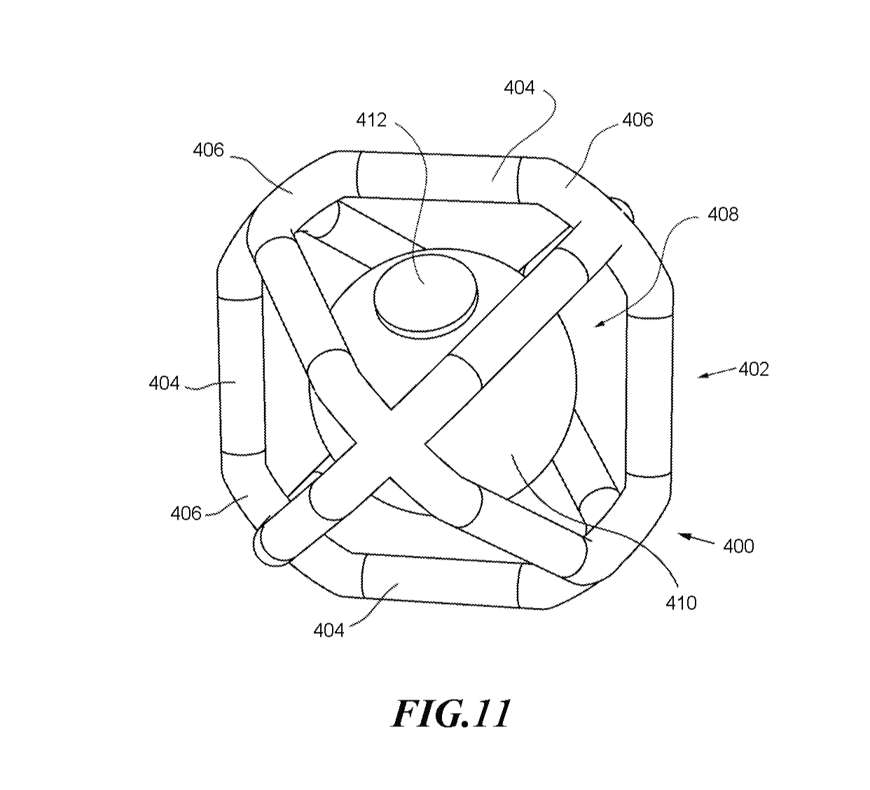

FIG. 11 is yet another exemplary embodiment of an exercise, fitness, and recuperative medicine device 400 of the invention. It is similar to the device of FIGS. 1 and 2, and has frame portion 402 formed of twelve handles 404 and bridge connectors 406. Openings 408 are formed between the handles 402. A vibratory core 410 is positioned in the center of the frame portion 402 and is connected thereto with standoffs (not shown). A control panel 412 is on the vibratory core 410 to control its various functions, as described above with respect to the embodiment of the device 100. This embodiment is suitable for users who wish to grip substantially straight handles 404 in lieu of curved handles. Although the cross-sectional profiles of the handles 404 are generally circular, they can have any desired profile.

The various controls and features, such as lights and sound can be incorporated into any of the embodiments of the device, and different numbers of handles can be used. Moreover, the vibratory can be of other design to create the vibrations.

The preferred embodiments of this invention have been disclosed, however, so that one of ordinary skill in the art would recognize that certain modifications would come within the scope of this invention. It is, therefore, to be understood that within the scope of the appended claims, the invention may be practiced otherwise than as specifically described.

What is claimed is:

1. An exercise, fitness, and recuperative medicine device, comprising:
a frame portion with a plurality of handles disposed around the frame portion, which handles are accessible via openings in the frame portion;
a vibratory core positioned in the interior of the frame portion, which vibratory core generates vibrational forces in the frame portion; and
a control panel to control operation of the vibratory core.

2. The exercise, fitness, and recuperative medicine device of claim 1, wherein the frame portions has at least two pairs of handles, wherein each handle in a pair of handles are disposed on opposite sides of the frame portion.

3. The exercise, fitness, and recuperative medicine device of claim 1, wherein the handles are joined to each other by bridge connectors.

4. The exercise, fitness, and recuperative medicine device of claim 3, wherein the vibrator core connects to the bridge connector.

5. The exercise, fitness, and recuperative medicine device of claim 3, where the frame portion comprises 12 handles and six bridge connectors with four connections points to connect to four handles each, with three handles connected to each bridge connector, wherein the frame portion define six faces.

6. The exercise, fitness, and recuperative medicine device of claim 1, further comprises lights and/or audio circuitry and a speaker.

7. The exercise, fitness, and recuperative medicine device of claim 1, wherein the control panel controls operations of the vibratory core selected from the group consisting of at least one of an on-off function, a timed operation function, vibration speed and intensity, operation of lights, and control of an audio output.

8. The exercise, fitness, and recuperative medicine device of claim 1, wherein the vibrator core provides vibratory forces along either one axis, two axes, or three axes.

9. The exercise, fitness, and recuperative medicine device of claim 1, wherein the vibrator core comprises an electric motor with a rotating shaft, a battery, and an offset weight that is mounted in an offset manner relative to the rotating shaft, which offset weight when rotated creates a vibratory force along at least two axes.

10. The exercise, fitness, and recuperative medicine device of claim 8, wherein the plurality of handles are oriented in a plurality of different axis or axes relative to the orientation of the axis or axes of vibration of the vibrator core.

11. The exercise, fitness, and recuperative medicine device of claim 1, wherein the handles are selected from a group consisting of generally straight rod sections and curved rod sections.

12. An exercise, fitness, and recuperative medicine device, comprising:
a frame portion with at least three pairs of handles disposed around the frame portion, which handles are accessible via openings in the frame portion, wherein the handles are joined to each other by bridge connectors, and wherein each handle in a pair of handles are disposed on opposite sides of the frame portion;
a vibratory core positioned in the interior of the frame portion and connected with standoffs to the bridge connectors, which vibratory core generates vibrational forces in the frame portion; and
a control panel to control operation of the vibratory core.

13. The exercise, fitness, and recuperative medicine device of claim 12, where the frame portion comprises 12 handles and six bridge connectors with four connections points to connect to four handles each, with three handles connected to each bridge connector, wherein the frame portion define six faces.

14. The exercise, fitness, and recuperative medicine device of claim 12, further comprises lights and/or audio circuitry and a speaker.

15. The exercise, fitness, and recuperative medicine device of claim 12, wherein the control panel controls operations of the vibratory core selected from the group consisting of at least one of an on-off function, a timed operation function, vibration speed and intensity, operation of lights, and control of an audio output.

16. The exercise, fitness, and recuperative medicine device of claim 12, wherein the vibrator core provides vibratory forces along either one axis, two axes, or three axes.

17. The exercise, fitness, and recuperative medicine device of claim 16, wherein the plurality of handles are oriented in a plurality of different axis or axes relative to the orientation of the axis or axes of vibration of the vibrator core.

18. The exercise, fitness, and recuperative medicine device of claim 12, wherein the vibrator core comprises an electric motor with a rotating shaft, and an offset weight that is mounted in an offset manner to the rotating shaft, which offset weight when creates a vibratory force along two axes, and a battery.
